(19) United States
(12) Patent Application Publication
(10) Pub. No.: US 2024/0349644 A1
(43) Pub. Date: Oct. 24, 2024

(54) METHOD FOR IMAGE EVALUATION OF AN OPERATING PARAMETER OF AN AGRICULTURAL HARVESTING HEADER DEVICE

(71) Applicant: Carl Geringhoff GmbH & Co. Kommanditgesellschaft, Ahlen (DE)

(72) Inventors: Rüdiger STEEN, Bunde (DE); Reimer TIESSEN, Oldenburg (DE)

(21) Appl. No.: 18/684,479

(22) PCT Filed: Aug. 15, 2022
(86) PCT No.: PCT/EP2022/072788

§ 371 Date: Feb. 16, 2024

(30) Foreign Application Priority Data
Aug. 17, 2021 (DE) 10 2021 121 366.5

(51) Int. Cl. A01D 41/127; A01D 41/14; G06T 7/00; G06V 20/10

(52) U.S. Cl. CPC A01D 41/127; A01D 41/141; G06T 7/0002; G06V 20/188; G06T 2207/20081; G06T 2207/30188; G06T 2207/30242; G06V 2201/06

(57) ABSTRACT

The present invention relates to a method for determining operating parameters of an agricultural harvesting header device (4) by way of software-aided image evaluation (10) of image datasets (100) from an optical sensor (6) in evaluation electronics (8) aimed at an area (12) cultivated by the harvesting header device (4). The invention also relates to a harvester having a data processing device and to a computer program product. In order to develop a method in which an operating parameter is acquired and evaluated and which is better suited to assessing the operating quality of the agricultural harvesting header device and to optimizing the settings of the components thereof, it is proposed for the image evaluation (10) of the image datasets (100) generated by the optical sensor (6) to be aimed at at least approximately determining a value (102) of the number of lost grains (22) able to be identified in the image dataset (100) as operating parameter.

### CROSS REFERENCE TO RELATED APPLICATIONS

This application claims priority under and is a National Stage of International Application No. PCT/EP2022/072788, filed Aug. 15, 2022, which is herein incorporated by reference in its entirety, including, without limitation, the specification, claims, and abstract, as well as any figures, tables, appendices, or drawings thereof. This application also claims priority under 35 U.S.C. § 119 to German Patent Application DE 10 2021121366.5, filed Aug. 17, 2021, which is herein incorporated by reference in its entirety, including without limitation, the specification, claims, and abstract, as well as any figures, tables, appendices, or drawings thereof.

### TECHNICAL FIELD

The present disclosure relates generally to a method for image evaluation of an operating parameter of an agricultural harvesting header by means of software-supported image evaluation of image data sets of an optical sensor in evaluation electronics, where the optical sensor is directed to an area worked by the harvesting header. The invention also relates to a harvesting machine with a data processing device and to a computer program product.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

A generic method is known from document EP 2 545 761 A1. In order to monitor the area worked and to determine parameters that can be used to control the harvesting machine, it is proposed to optically capture the area worked directly behind the harvesting header and to evaluate the captured data in order to draw conclusions about the nature of the area worked. Information for setting the harvesting machine and for subsequent work steps should also be derived. In particular, harvested crop losses at the harvesting header should also be reduced by accordingly matching the individual components of the harvesting header to each other and based on the soil condition. As a means of reducing the harvested crop losses by means of improved setting of the components of the harvesting header, an assessment of the stubble quality is indicated.

It has been found that the assessment of the stubble quality by means of image evaluation does not provide a reliable assessment basis for determining the working quality of the agricultural harvesting header and optimizing the settings of its components.

Thus, there exists a need in the art for a reliable assessment basis for determining the working quality of the agricultural harvesting header and optimizing the settings of its components.

### SUMMARY

The following objects, features, advantages, aspects, and/or embodiments, are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

The object of the present invention is to develop a method in which an operating parameter is captured and evaluated, which method is better suited to assessing the working quality of the agricultural harvesting header and optimizing the settings of its components.

The object is achieved for a generic method by virtue of the image evaluation of the image data sets generated by the optical sensor being aimed at least approximately determining, as operating parameters, a respective value for the number of lost grains recognizable in the image data set. The object is achieved for a harvesting machine with a data processing device by virtue of the harvesting machine comprising a means for carrying out this method. The object is achieved for a computer program product by virtue of the computer program product comprising instructions which, when the method is carried out by a computer, cause the computer to carry out this method.

A certain value for the number of lost grains is better suited to assessing the working quality of an agricultural harvesting header. The number of lost grains determined immediately indicates the efficiency of the harvesting header, while the stubble quality is not in a clearly assignable functional relationship with the number of lost grains that result from the current settings of the individual components when operating the agricultural harvesting machine. The value for the number of lost grains can be very high if the stubble pattern is flawless due to the incorrect setting of the harvesting header, whereas, if the stubble pattern is not satisfactory, there may be only a small number of lost grains because the cereal grains will not be lost with the selected setting of the components of the harvesting header. If the working quality of the agricultural harvesting header were now to be assessed on the basis of the stubble pattern, there would be no need for correction with the flawless stubble pattern, even though considerable losses are incurred, whereas the unsatisfactory stubble pattern would assume a need for regulation which is not actually present at least with regard to the level of grain loss. The stubble pattern is only suitable for assessing the working quality of the harvesting header in extreme working situations, such as in the case of stored cereals, damage to the harvesting header, or in swampy soil conditions, but not in normal operating situations, which largely determine the daily operation of agricultural machinery. At this point, it should be noted that the term “lost grains” refers not only to individual grains in the narrower sense, but also to ears, pods, corn cobs, and the like, in which the lost grains still adhere to the seed head, but then the seed heads with the lost grains adhering thereto are lost, in which case damaged seed heads with lost grains still adhering thereto can also be the subject of image evaluation.

The image evaluation of the number of lost grains recognizable in the image data set for the purpose of determining the working quality of a harvesting header is also advantageous because the current loss level of a harvesting machine that is assumed by the driver is often used to regulate the forward speed of the harvesting machine. However, to date, only loss sensors that measure the losses in separation technology and the cleaning of a combine harvester are decisive for the assessment of the loss level by the driver. However, only losses of harvested crop fractions that have completely passed through the harvesting machine are measured and made the basis for decisions. The losses that already occur in the region of the harvesting header and do not enter the harvesting machine at all have to this day been ignored when determining the working speed based on sensor data from the machine, even though these can have a considerable influence on the overall loss level of the harvesting process and thus on its overall profitability. In case of doubt, the working speed will be incorrectly selected based on the current loss level assumed by the driver if a significant proportion of the total process losses of the machine harvest are not captured. The harvested crop losses that occur in the cutting unit must be observed and assessed by the driver, which becomes more and more difficult as the working width of the cutting units increases, and the driving speed of the harvesting machines increases.

This is all the more surprising because the capacity of a harvesting header used today can be a major performance-limiting factor of a modern harvesting machine. Today, modern harvesting machines use harvesting headers with working widths of more than 10 m, without reaching the performance limit of the threshing unit, the separation technology, the cleaning, and the motors, even at higher driving speeds of the harvesting machines. Under these harvesting conditions, the harvesting header operates at its performance limit, but is nevertheless the performance-limiting factor of the overall machine system. In order to utilize the following components of the harvesting machine, it is necessary to make the best possible use of the performance potentials of the cutting unit. However, the closer the harvesting header is moved to its performance limit, the more important it is to capture and assess the loss level that occurs there.

The option of accurately assessing the loss level of the harvesting header provides a completely new basis for assessing the setting of the forward speed of the harvesting machine. If the capacity of the harvesting header is the performance limit for the overall system of the harvesting machine with the harvesting header, it is now possible to adjust the forward speed only or at least predominantly on the basis of the loss level of the harvesting header, while the other loss sensors installed in the harvesting machine are only or subordinately used to optimize the settings of the working components of the harvesting machine.

The possibility of determining the loss level of the harvesting header is now available for the first time via an optical sensor with software-supported image evaluation that is connected thereto and is used to evaluate the image data sets generated by the optical sensor, as operating parameters, for the number of lost grains that are recognizable in the image data set. The software-supported image evaluation offers various possibilities and mathematical methods, including artificial intelligence, for extracting that information, which indicates the presence of a lost grain from the respective image data sets.

This allows the grayscale or color space values that indicate a lost grain to be recognized in an extraction step from one or more pixels of an image data set. Depending on how high the resolution of the original image is, the evaluation electronics can calculate image values for each individual pixel or for pixel fields in which the image values of a plurality of pixels are considered together. Considering pixel fields makes it possible to reduce the complexity of the calculations without necessarily having to lead to a loss of quality in the determination of the number of lost grains. Color RGB images can be converted into grayscale images and vice versa in order to increase the recognition accuracy by converting color values into brightness values and vice versa. In color images, the color channels of the individual pixels can be evaluated differently or calculated further without the color values.

In a further extraction step, the geometries and/or areas of contiguous pixels with a comparable grayscale or color space value can be compared with a geometry to be expected for a lost grain and/or an area value to be expected for lost grains. From such processing of the image data sets determined by the optical sensor, the number of lost grains recognizable in the image data set can then be determined at least approximately. Other appropriate mathematical and static processing rules can be used to improve the recognition accuracy of the image evaluation.

As a result, it is possible to use the image evaluation of the image data sets of an optical sensor to obtain statistically reliable statements, which are sufficiently accurate for the intended purpose, about the number of lost grains which can be recognized in that section of the area worked by the harvesting header behind the harvesting header which is viewed by the optical sensor. The optical sensor may be directed to the partial area of the area worked by the harvesting header corresponding to a partial working width of the harvesting header.

A single optical sensor, which only observes a partial area corresponding to a partial working width, already enables a statement on the number of lost grains recognized in the harvested area. It is also possible, of course, to arrange a plurality of optical sensors spread over the working width of the harvesting header, each generating electronic camera images with corresponding image data sets. It is then possible to independently evaluate and further process each image data set of each individual optical sensor, but the image data sets of a plurality of optical sensors can also be processed together by the evaluation electronics, and a common value for the recognized lost grains can be output for them.

Insofar as it is mentioned here that the number of lost grains recognizable in the image data set can be at least approximately determined, this should be understood as meaning, in a narrower sense, the numerical determination of the lost grains recognized in an image data set. However, this feature is not limited to this narrow understanding. Instead of a numerical value for the number of recognized lost grains, this statement should also be understood as meaning a relative value, for example, a percentage, assumed by the recognized lost grains in the number of evaluated pixels, or a simple indicator value that indicates a low/average/high loss level in any gradation, or a trend value that only indicates whether the number of lost grains increases or decreases in relation to a previously determined value for the number of lost grains. Such a trend value is of particular interest when it is observed whether a desired change in the loss level is achieved by adjusting the setting of components of the harvesting header. The image evaluation uses the number of lost grains recognized in the image data set or the relative values derived therefrom to determine the value for the number of lost grains recognizable in the image data set, which value then forms, as a signal, a basis for optimizing the harvesting header and/or the harvesting machine.

It goes without saying that a camera is designed as an optical sensor on the harvesting header in such a way that it still delivers usable sensor values under the difficult operating conditions of agricultural technology. In particular, a digital or electronic camera, which calculates images directed to an image sensor into an image data set, such as is carried out, for example, by CCD image sensors as light-sensitive electronic components, is considered as a camera. For example, a camera must be adequately sealed against dirt, it must be cleaned with a high-pressure cleaner, it must be protected against vibrations and shocks, possible electrostatic charges must not affect the quality of the image files, no condensation must form on the lenses, and, if necessary, additional headlights must be installed on the harvesting header in order to improve the quality of the image files in difficult light conditions.

The area which is worked by the harvesting header and to which the optical sensor is directed may be the area immediately behind the harvesting header in the gap between the rear wall of the harvesting header and the chassis parts of the harvesting machine, such as the wheels or crawler tracks at the time at which an image data set is created. This region is still unaffected by the ruts of the harvesting machine. However, it is also possible to consider the area below the harvesting header at the time at which an image data set is created. This region, in particular, is well shielded by the harvesting header from dust generated by the harvesting machine or other vehicles in the field. The region may also be under a conveyor unit of the harvesting machine, such as a slope conveyor of a combine harvester, or between the axles of the harvesting machine, because these regions are also well covered by the harvesting machine against dust. Poorer light conditions in these regions can be compensated for by appropriate light-emitting means, such as spotlights or flashlights. In order to be able to create good image data sets from the corresponding areas, the optical sensor is installed at a suitable location. This may be the case on the rear wall of the cutting unit, above the rear wall of the cutting unit, under the cutting unit, in front of or behind the cutter bar, on the side of the cutting unit, or at a mounting position on the harvesting machine, for example in the region inside or outside the driver's cab, under or next to the slope conveyor, in the region of the axle, or above or behind the wheels or crawler tracks.

The harvesting headers equipped with the optical sensor can be all types of harvesting headers that pick up the harvested crop from the field and deliver it to an associated harvesting machine. In particular, grain-cutting units with screw or belt conveyor systems, maize pickers, maize headers conveying in a rotating manner or in a linear movement, pick-up devices, and the like are considered here.

According to one configuration of the invention, the value for the number of recognized lost grains is evaluated in a control loop by evaluation electronics, in which it is assessed in a first stage whether or not the value for the recognized lost grains is acceptable, the evaluation electronics output a signal for increasing the driving speed of the agricultural machine if the value is assessed to be acceptable, and it is decided in a second stage whether the evaluation electronics will output a signal for reducing the driving speed of the agricultural machine and/or a signal for changing settings of the components of the harvesting header if the value is assessed to be unacceptable. If no lost grains are recognized, this means that the settings of the components of the harvesting header initially do not need to be changed, and the current settings of the components of the harvesting header are optimal for the selected driving speed of the agricultural machine. Based on this finding, it would be possible to increase the driving speed of the agricultural machine in order to check whether the settings of the components of the harvesting header can be maintained even at a higher driving speed or whether an increased number of lost grains can be detected at the higher driving speed.

According to one configuration of the invention, contamination detection of the sensor is integrated in the image evaluation. If the values of the image data sets for one or more pixels do not change when the machine is moving forward, the corresponding pixels can be assessed to be “dirty” because, without any contamination covering the lens, the individual pixel values would have to change continuously when the harvesting machine is moving forward. Since these pixels can no longer contribute to lost grain detection, the recognition accuracy of the image evaluation deteriorates all the more, the more pixels are dirty. Up to a certain degree of contamination, the determined value of the lost grain recognition can be corrected, and/or the pixels recognized as “dirty” are no longer taken into account in the image evaluation. However, from a certain degree of contamination, the image evaluation can no longer provide reliable data about the recognized grain losses. In this case, the image evaluation should be aborted, and an error signal indicating the excessive contamination of the camera sensor should be sent to a control device.

According to one configuration of the invention, the image evaluation is carried out according to parameters differentiated in a harvested-crop-specific manner. The harvested crop can be roughly distinguished between those crops for which the harvesting header picks up all the plants and forwards them to the harvesting machine without processing, so that the processes of separating, sifting, and cleaning are carried out there, and those crops for which the harvesting header already takes over work shares of one or more of these processes. Examples of the former crops are wheat, rye, barley, soya, and rapeseed, and examples of the second crops are grain maize. While, for the former crops, only the mown stubble remains in the field, between which the lost grains can be easily recognized, in the case of the grain maize harvest, the maize plants are separated in the harvesting header between the cob and the remaining plant components. Only the cobs are transported to the harvesting machine for further processing: the remaining plant components are discarded by the harvesting header onto the field, and there form a material mat extensively covering the ground, between which it is harder to identify corn cobs or individual maize grains. Lost corn cobs should also be included in the loss recognition with a loss number, as they contain a larger number of maize grains. In order to obtain useful values here for the number of lost grains and/or ears and/or cobs that are recognizable in the image data set, parameters, which are differentiated in a harvested-crop-specific manner and according to which the image evaluation is performed, must be programmed in the image evaluation software.

For example, there can be a correction factor for the grain maize harvest, because the image evaluation can be used to recognize only individual maize grains resting on the material mat, but other maize grains are hidden in the material mat. The image evaluation software may have evaluation algorithms, which are differentiated in a harvested-crop-specific manner and take into account the image of the material mat that is different due to the material mat in relation to normal arable land, such as the different color and structure of the leaf and stem parts lying on the field. However, the image evaluation for the former crops can also be more precisely differentiated in itself, because, for example, different color values, different geometric shapes, and different degrees of maturity must be taken into account for the recognition of black rapeseed grains and yellow wheat grains, in order to recognize as accurately as possible, the number of lost grains recognizable in the image data set with an accuracy sufficient for evaluation purposes. Advantageously, the respective crop type to be harvested can be manually input to the evaluation electronics before the start of harvesting, or the evaluation electronics run through an operating loop of the automated crop type recognition, in which they first recognize the respective crop type by means of the image evaluation, and then the programming required for the respective crop-type-specific image evaluation is activated.

According to one configuration of the invention, a plurality of successive image data sets of the optical sensor, for forming an average value and limit value of the pixel values, are calculated to form a new image data set, for which a value for the number of lost grains is determined. Since, in the image data set of a single camera image of the optical sensor, the lost grains statistically do not have the exact same texture and color as in another camera image and in particular local grayscale value or color fluctuations can occur, there is the risk of such fluctuations leading to assessment errors. The proposed calculation of a plurality of image data sets to form a new image data set as the average image means that the fluctuations are compensated for via the averaging and assumes, in the new image data set, a grayscale or color value averaged from the individual camera images calculated together. When this description refers to the “average image”, on the basis of which image evaluations are performed, this does not always mean only precisely the average image in the narrow sense, which results from the averaging of the grayscale or color values of the individual pixels from the camera images, but in a broader sense also those images and the grayscale or color values contained therein and other information resulting from further processing of the average image in the narrower sense, such as a binarized image, in which the pixels are only digitally represented as “lost grain” or “not lost grain”. However, other metrics can also be used to form an average value. For example, the pixels representing a lost grain generally have a lighter or darker grayscale or color scale value than the other material shown in the camera image, and they may also have a lower standard deviation or a lower variance. Therefore, the standard deviation or the lower variance can also be determined instead of the arithmetic average value. Other methods can also be used as a metric for forming an average value for combining a plurality of images, such as the formation of a geometric or harmonic average, the formation of average values in different color spaces, the determination of weighted average values, the determination of spatial or temporal gradients of brightness and/or color, the use of high-pass, low-pass or other filters, without this exemplary list being restricted to the methods mentioned.

According to one configuration of the invention, the evaluation electronics calculate the values determined with the image evaluation for the number of lost grains recognized in the image data set over a time interval into a trend line, register any changes made in the settings of one or more operating parameters of the harvesting header and temporally assign them to the trend line, and, when there is a temporal coincidence between the beginning of a change of the trend line and the change in the settings of one or more operating parameters, assess whether the trend line increases or decreases since the change in the settings of one or more operating parameters, and use the result of the assessment to generate a signal indicating whether the change made in the settings of one or more operating parameters increases the determined grain losses, leaves them unchanged or decreases them. Assessing changes in the settings of one or more operating parameters of the harvesting header helps to set the components of the harvesting header so as to keep the loss level as low as possible. For example, in the case of a grain cutting unit as a harvesting header, the angle of attack of the cutting unit overall, the working height of the cutting unit, the height of the reel, the horizontal position of the reel relative to the cutter bar, the reel speed, the angle of attack of the reel tines, the cutting frequency of the cutter bar, the conveyor speed of the conveyor elements for delivering the harvested crop, blowers for supporting crop pick-up and speeds of side cutters and side bearing screws are adjustable. A plurality of different operating parameters is also adjustable in the case of maize pickers. The large number of resulting possible ways of influencing the loss level of the cutting unit or other harvesting header makes it difficult to correctly assess the effect of a change made to an operating parameter. Using the proposed method, it is now possible to verify the effect of a changed setting on the loss level using the image evaluation. Since the loss level is continuously monitored over a time interval via the trend line, the adjustable parameters can be addressed and assessed successively and in a continuous optimization loop.

According to one configuration of the invention, a value determined by the image evaluation for the number of lost grains recognizable in the image data set is used as the input to an automated software-controlled control loop, in which at least one first operating parameter of at least one adjustable first component of the harvesting header is changed by control electronics in order to use the evaluation electronics to assess, after the change that has been made, by means of a new value, whether the loss level of the harvesting header has been reduced by adjusting the first operating parameter and is assessed to be satisfactory, the first operating parameter of the first component continues to be changed until a loss level of the harvesting header, which is assessed to be satisfactory by the control electronics by means of a new value, is achieved, then at least one second operating parameter of the adjustable first component or of a second component of the harvesting header is changed by the control electronics in order to use the evaluation electronics to assess, after the change that has been made, by means of a new value again, whether the loss level of the harvesting header has been reduced by adjusting the second operating parameter and is assessed to be satisfactory, and the second operating parameter of the first or second component also continues to be changed until a loss level of the harvesting header, which is assessed to be satisfactory by the control electronics by means of a new value again, is achieved, and this adjustment of one or more further operating parameters of the first, second or other further component is continued by the evaluation electronics until a setting of the operating parameters that are variably settable by the evaluation electronics, for which the harvesting header with the set operating parameters of the components has been set to the lowest possible loss level, has been achieved.

The reel of a grain cutting unit can be used as an example of an adjustable first component. As adjustable operating parameters of the reel, it is possible to specify, for example, its speed, its height, its horizontal distance from the cutter bar, and the angular position of the reel tines. The value determined by the evaluation electronics can now be used by the evaluation electronics to change the setting of the individual operating parameters of the reel in such a way that the lowest possible loss level of the harvesting header is achieved. It is suggested to initially start with a first operating parameter, such as the reel height, to adjust it up or down in one direction in order to then use a new value to check whether the loss level has improved. If no improvement or a deterioration has been detected, an adjustment in the opposite direction can be attempted in order to first recognize the correct optimization direction of the adjustment. If an improvement has been recognized after the first adjustment, the adjustment can be continued in the same direction. The adjustment can be continued in small steps in the direction recognized as correct until no further optimization of the operating parameter in this direction appears to be possible, which in turn can be determined based on the values generated by the evaluation electronics. It is then possible to optimize a second operating parameter of the reel, such as the horizontal position of the reel relative to the cutter bar. The adjustment strategy is here exactly the same as described above for the reel height; first, the optimization direction is determined and then adjusted until an optimal setting of the changed parameter has been recognized. In this way, all variable operating parameters of a first component can be set successively to an optimal loss level. The adjustable operating parameter settings of a second component, then the third component, and so on can then be optimized accordingly, or, after the first operating parameter of the first component, the first operating parameter of the second component is optimized, then the second operating parameter of the second component, and then the first operating parameter of the third component, that is to say in a sequence which makes it possible to achieve a loss-optimized setting of the components of the harvesting header in the quickest manner. Functional dependencies must be taken into account when determining the sequence.

In the described manner, the value for the number of lost grains recognizable in the image data set, as determined by the image evaluation, can be used as the input to an automated software-controlled control loop. The value determined by the image evaluation for the number of lost grains recognizable in the image data set provides a good basis for assessment in order to automatically set the adjustable operating parameters of the harvesting header in such a way that the lowest possible loss level of the harvesting header is achieved. The setting can be made in particular in a control loop that is programmed in the associated software. Due to the number of possible adjustments of the plurality of components and their plurality of operating parameters, corresponding manual tracking is far too complex to be able to be performed continuously by a driver, especially since the driver has hardly any chance to approximately accurately estimate the current loss level of the harvesting header from the cab. In addition, the conditions in a field can change constantly, and so a loss-optimized setting found for one point in the field being traversed can result in high losses of the harvesting header at another point in the field. Constantly identifying available optimization options and optimally adjusting the operating parameters here would completely overwhelm a driver. The continuous optimization of the setting of the various operating parameters of the components of the harvesting header by means of the automated software-controlled control loop makes it possible to recognize otherwise wasted optimization potentials via the image evaluation of the camera images and to also implement them. The control loop can run continuously, but it is also possible to switch on the control loop when a need is recognized and switch it off again after an optimized setting has been reached.

The evaluation electronics can be the electronics that evaluate the image data sets of the optical sensor, but can also be other evaluation electronics arranged on the harvesting header or on the harvesting machine. The evaluation electronics consists of hardware and corresponding software. The control electronics can be physically the same hardware computer chips on which the software of the evaluation electronics also runs, but can also be separate electronics. The control electronics are the controller that controls the actuators used to change the operating parameters of the components of the harvesting header. The control electronics receive actuating signals from the evaluation electronics, which transmit them as actuating commands to the actuators of the respective components.

According to one configuration of the invention, the sequence of optimization of the individual operating parameters is variable depending on the respective field crop to be harvested, detected soil conditions, stored cereals that occur, yield map data from previous harvests, height of the harvested crop stock, degree of moisture and/or degree of maturity of the harvested crop. Depending on the field crop, it may be advantageous to first adjust a certain operating parameter, in order to work as quickly as possible toward a setting of the operating parameters for this field crop at which a low loss level is achieved, which is different from another operating parameter which is preferable for another field crop. It is equally possible for the soil conditions in a field to change or for stored cereals to occur in certain regions. Equally, the height, the degree of moisture, and/or the degree of moisture of the harvested crop can differ depending on water supply, fertilization, weeds and disease infestation, sun exposure, slope position, and other influencing factors. With such different harvesting conditions, it may also be advantageous to adjust the sequence of optimization of operating parameters to the respective prevailing harvesting conditions. It is equally advantageous to use data from yield maps created during previous harvests to derive an optimized sequence of the operating parameters to be adjusted.

According to one configuration of the invention, the value determined by the image evaluation for the number of lost grains recognizable in the image data set, the trend line, and/or an indicator value derived therefrom is transmitted from the evaluation electronics to a display unit and displayed by the latter in a display. The display unit may be installed on the harvesting header, but it may also be a display unit arranged away from the harvesting header. The display may be an operating screen of the harvesting machine, but it may also be a display that is present on the harvesting machine for separate operation of the harvesting header. However, the display can also be effected on a control station that is operated away from the harvesting machine. The value, the trend line and/or an indicator value derived therefrom can be monitored by an operator of the harvesting machine via the display unit and can be made the basis of control commands for operating the harvesting machine. The displayed values, the trend line. and/or indicator values derived therefrom can be stored via the display unit and used for evaluation or documentation purposes.

According to one configuration of the invention, the evaluation electronics output an alarm signal when a preset or optionally settable threshold value for the value determined by the image evaluation for the number of lost grains recognizable in the image data set, the trend line, and/or an indicator value derived therefrom is exceeded. The output of an alarm signal simplifies operation, because the development of the value determined by the image evaluation for the number of lost grains recognizable in the image data set no longer has to be constantly monitored by the driver of the harvesting machine, but rather the driver is automatically alerted only when the reaching of the threshold value indicates that a control intervention in the current settings of the harvesting header and/or of the harvesting machine is necessary.

According to one configuration of the invention, the evaluation electronics store the determined values for the number of lost grains recognizable in the image data set, the trend line, and/or indicator values derived therefrom in a georeferenced manner in a loss map. So that the evaluation electronics can store the corresponding data in a georeferenced manner, the evaluation electronics preferably have a module, which can be used to receive the data from a satellite navigation system. Linking the position data to the loss data determined produces a loss map, which enables subsequent evaluation of the harvesting work as well as more precise planning of the subsequent tillage, sowing, and care of the subsequent crops. In particular, the loss map can be linked to other georeferenced data in order to be able to make optimized decisions in the management of the corresponding arable land when considered together with these other georeferenced data.

According to one configuration of the invention, the evaluation electronics have interfaces to external systems. On the one hand, the complexity of the software and/or hardware of the evaluation electronics can be reduced by way of the interfaces by transferring sub-functions of the image evaluation to other electronics via the interface. The sub-functions can be data acquisition, data storage, and the execution of software programs that cover sub-functions of the evaluation electronics. The other electronics can be connected to the evaluation electronics, in particular via mobile radio and the Internet. The other electronics can be, for example, expert systems running on a central server. However, the interfaces can also serve the purpose of networking the harvesting header to the harvesting machine. The function of the harvesting header can then be better matched to the functions of the harvesting machine, in particular to allow operational optimizations.

The interface may be, in particular, an interface for controlling the forward speed of the harvesting machine. The evaluation electronics can further process the determined values for the number of lost grains recognizable in the image data set, the trend line, and/or indicator values derived therefrom to form a signal, which is used to reduce or increase the forward speed of the harvesting machine. In order for this signal to be able to be transmitted to the control electronics of the harvesting machine, a corresponding interface in the evaluation electronics is required.

In particular, the interface may also be an interface for automatically adjusting the threshing. separating, and/or cleaning elements of the harvesting machine. The evaluation electronics can further process the determined values for the number of lost grains recognizable in the image data set, the trend line, and/or indicator values derived therefrom to form a signal which can be used to adjust the threshing, separating, and/or cleaning elements of the harvesting machine. In order for this signal to be able to be transmitted to the control electronics of the harvesting machine, a corresponding interface in the evaluation electronics is required.

In particular, the interface can also be an interface to the cloud. The cloud is a computer network that provides shared computer resources as a service, for example, in the form of servers, data memories, or applications, in a timely manner and with little effort, if required-usually via the Internet and in a manner independent of the device. Usage access to application programs or function inputs can be provided via the cloud. Programming or runtime environments with flexible, dynamically adaptable computing and data capacities are also possible.

According to one configuration of the invention, the area, to which the optical sensor is directed, is brightened during the creation of an image data set by a light-emitting means attached to the harvesting header. The light-emitting means can produce normal white light. but it is also possible for the light-emitting means to only generate light waves from a certain range of wavelengths, with which the lost grains are better recognized by the image evaluation. U.V., black light or infrared light or other light colors from the spectrum of visible wavelengths can also be used, or the respective light color and/or wavelengths is/are selected depending on the crop and light conditions.

According to one configuration of the invention, image data sets of lost grains, which are compared with the image data sets transmitted by the optical sensor, are accessible in the image evaluation of the evaluation electronics. The accessible image data sets are used to improve the recognition quality of lost grains in the image evaluation. The accessible image data sets can also be stored remotely in the cloud. Especially in the case of self-learning artificial intelligence systems, the recognition quality and reliability of the algorithms can be continuously improved by the algorithms integrating the information obtained from the various image data sets for the identification of lost grains in a running image evaluation and storing it for subsequent evaluation of new image data sets. Various mathematical analysis algorithms, but also different color filters, contrasts, geometric shapes, and the like, can be used when comparing the accessible image data sets with the image data sets to be evaluated.

According to one configuration of the invention, algorithms for self-learning systems are integrated in the software of the evaluation electronics. The self-learning systems use algorithms that enable machine learning. These algorithms can be programmed for supervised learning, during which data sets are flagged such that patterns are recognized and are then used to flag new data sets. However, the algorithms can also be programmed to process data sets that are not flagged, sort the data sets according to similarities or differences, and derive recognition patterns from them that can be used to improve the recognition quality and recognition reliability. Finally, the algorithms can also be programmed for reinforcement learning, in which data sets are not flagged, but feedback is given to the A.I. system after one or more actions. The algorithms for self-learning systems work particularly well when the evaluation electronics in a neural network communicate and exchange data with external computers.

Further features of the invention emerge from the claims, the figures, and the concrete description. All the features and combinations of features mentioned above in the description, as well as the features and combinations of features mentioned below in the description of the figures and/or shown in the figures alone, can be used not only in the respectively stated combination, but also in other combinations or alone.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

The invention will now be explained in more detail using a preferred exemplary embodiment and with reference to the accompanying drawings,

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows a side view of a harvesting machine with a harvesting header attached to the front.

FIG. 2 shows a schematic data flow diagram.

FIG. 3 shows a diagram of a possible progression of a trend line.

FIG. 4 shows a schematic program flow chart.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

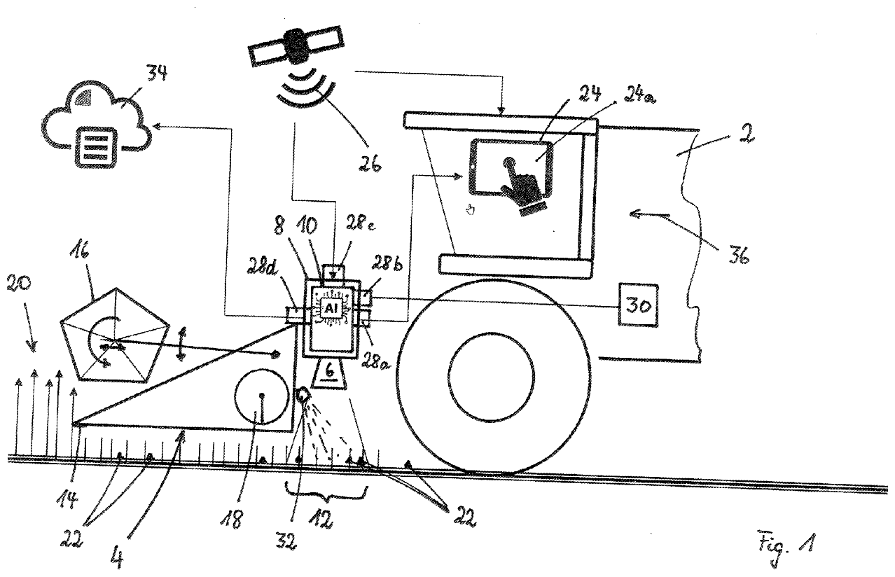

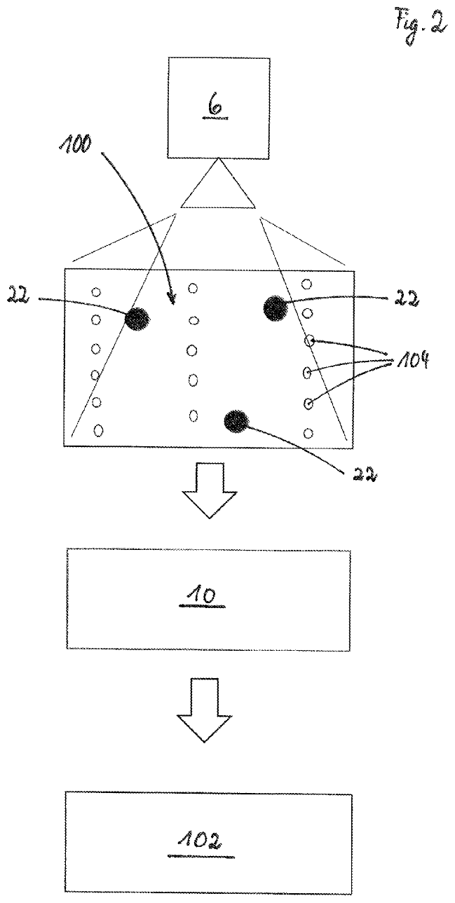

FIG. 1 shows a side view of a harvesting machine 2 with a harvesting header 4 attached to the front. Behind the rear wall of the harvesting header 4 is an optical sensor 6, which is directed to the area 12 of the arable land. The optical sensor 6 is connected to evaluation electronics 8, which has a device for image evaluation 10. The images created by the optical sensor 6, in particular in the form of image data sets 100, see FIG. 2, can be examined by the image evaluation 10 for the number of lost grains 22 recognizable in the image data set 100.

The harvesting header 4 shown in FIG. 1 is a grain-cutting unit. The grain cutting unit has a cutter bar 14, a reel 16, and a screw conveyor 18. The harvested crop 20 in the field is cut using the grain cutting unit, is pulled into the grain cutting unit, and is delivered to the harvesting machine 2. When sensing, cutting, and pulling in the harvested crop 20, it is possible for lost grains 22 to fall onto the arable land, with the result that they can no longer be harvested by the harvesting machine 2. The number of lost grains 22 that arise may depend on settings of the operating parameters of components of the harvesting header 4 and on the forward speed of the harvesting machine 2. When the optical sensor 6 looks at the area 12, the lost grains 22 lying on the arable land are visible and recognizable by the image evaluation 10.

In the driver's cab of the harvesting machine 2, there is a display unit 24 with a display 24a, which is connected to the evaluation electronics 8. The connection can be wired or wireless. For the connection to the display unit 24, the evaluation electronics 8 has a corresponding interface 28a. Another interface 28b is connected to the harvesting machine electronics 30. This interface 28b can be used to exchange information and actuating commands relating to the driving speed 36, the setting of the threshing, separating and cleaning elements, and the like. Via the interface 28c, the evaluation electronics 8 receive position data from a satellite navigation system 26. The evaluation electronics 8 can communicate with the cloud 34 via the interface 28d.

A light-emitting means 32 is installed on the rear wall of the harvesting header 4. The light-emitting means 32 illuminates the area 12, so that lost grains 22 lying there on the arable land can be better recognized by the image evaluation 10.

FIG. 2 shows a schematic data flow diagram. As the harvesting machine 2 travels over a field, the optical sensor 6 generates a number of image data sets 100, one example of which is shown as an image in FIG. 2. The stubble 104 of the cut-harvested crop 20 can be seen in the image. Between the stubble 104 are three lost grains 22 in the exemplary embodiment. The respective image data set 100 is transmitted to the image evaluation 10 located in the evaluation electronics 8. The image data set 100 is digitized. The image evaluation 10 analyzes, in a software-supported manner, which the number of lost grains 22 is recognized by it in the image data set 100. A value 102 for the number of lost grains 22 recognizable in the image data set 100 is generated from the number of recognized lost grains 22.

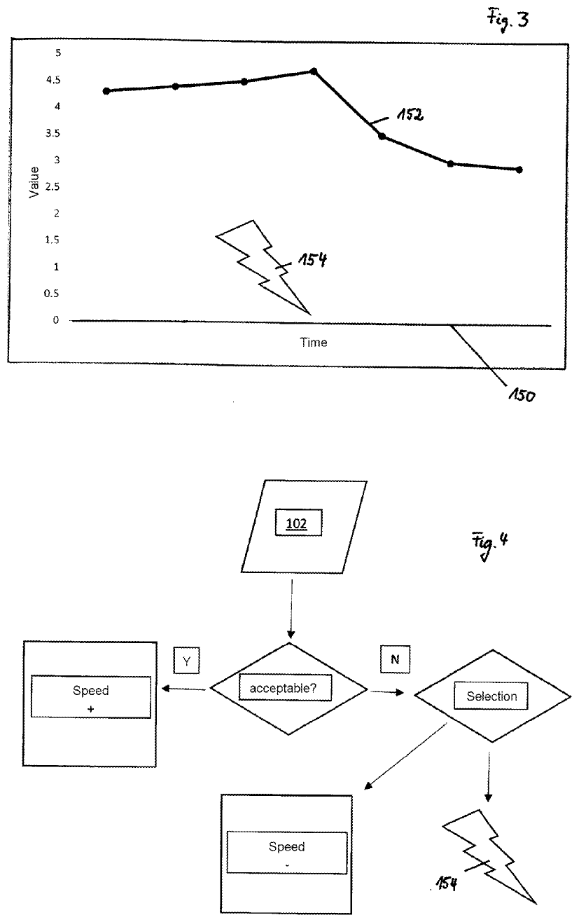

FIG. 3 shows a possible progression of a trend line 152 over a time interval 150. In a first section, the trend line 152 of the value 102 for the number of lost grains 22 recognizable in the image data set 100 is at a value >4, while the separation line 152 drops in a second section and adjusts to a value of approximately 2.6. The drop in the trend line 152 is explained by a change 154 made to an operating parameter of a component of the harvesting header 4. As a result of the change 154 made, the value 102 has therefore decreased. The evaluation electronics 8 can now decide whether the change 154 previously made to an operating parameter of a component is continued in the same direction, or whether the achieved loss level is satisfactory to then change another operating parameter of the same component or another component. If the trend line 152 increased after the change 154 was made, the evaluation electronics 8 could withdraw the change 154 made again and adjust the corresponding operating parameter in the opposite direction or adjust another operating parameter of the same component or another component.

FIG. 4 shows a schematic program flow chart that can take place when deciding whether the driving speed 36 of the harvesting machine 2 should be reduced or increased. Based on the determined value 102, it is necessary to assess in a first step whether or not the determined loss level is acceptable. If the loss level is acceptable, the driving speed 36 can be increased. If the determined loss level is not acceptable, it is necessary to select in a further step whether the driving speed 36 of the harvesting machine 2 should be reduced or whether an operating parameter of a component of the harvesting header 4 should be adjusted with a change 154. The exemplary program flow chart can be stored in the software of the evaluation electronics 8.

The invention is not limited to the above exemplary embodiments. A person skilled in the art has no difficulty in modifying the exemplary embodiments in a manner that appears appropriate to him in order to adapt them to a specific application.

From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 2 | Harvesting machine |
| 4 | Harvesting header |
| 6 | Optical sensor |
| 8 | Evaluation electronics |
| 10 | Image evaluation |
| 12 | Area |
| 14 | Cutter bar |
| 16 | Reel |
| 18 | Screw conveyor |
| 20 | Harvested crop |
| 22 | Lost grains |
| 24 | Display unit |
| 24a | Display |
| 26 | Satellite navigation system |
| 28 | Interfaces |
| 28a | First interface |
| 28b | Second interface |
| 28c | Third interface |
| 28d | Fourth interface |
| 30 | Harvesting machine electronics |
| 32 | Light-emitting means |
| 34 | Cloud |
| 36 | Driving speed |
| 100 | Image data set |
| 102 | Value |
| 104 | Stubble |
| 150 | Time interval |
| 152 | Trend line |
| 154 | Change |

### GLOSSARY

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

1-17. (canceled)

18. A method for determining operating parameters of an agricultural harvesting header (4) comprising of:
utilizing software-supported image evaluation (10) of image data sets (100) of an optical sensor (6) in evaluation electronics (8), which optical sensor (6) is directed to an area (12) worked by the harvesting header (4), wherein the image evaluation (10) of the image data sets (100) generated by the optical sensor (6) is aimed at least approximately determining, as operating parameters, a value (102) for the number of lost grains (22) recognizable in the image data sets (100).

19. The method for determining operating parameters of an agricultural harvesting header (4) as claimed in claim 18, further comprising:
determining that the value (102) for the number of recognized lost grains (22) is evaluated in a control loop by the evaluation electronics (8);
accessing in a first stage whether or not the value (102) for the recognized lost grains (22) is acceptable;
outputting with the evaluation electronics (8) a signal for increasing the driving speed (36) of the agricultural machine if the value (102) is assessed to be acceptable; and
determining in a second stage whether the evaluation electronics (8) will output a signal for reducing the driving speed (36) of the agricultural harvesting header (4) and/or a signal for changing settings of the components of the harvesting header (4) if the value (102) is assessed to be unacceptable.

20. The method for determining operating parameters of an agricultural harvesting header (4) as claimed in claim 18, wherein contamination detection of the sensor (6) is integrated in the image evaluation (10).

21. The method for determining operating parameters of an agricultural harvesting header (4) as claimed in claim 18, wherein the image evaluation (10) is carried out according to parameters differentiated in a harvested-crop-specific manner.

22. The method for determining operating parameters of an agricultural harvesting header (4) as claimed in claim 18, wherein the plurality of successive image data sets (100) of the optical sensor (6), for forming an average value and limit value of the pixel values, are calculated to form a new image data set (100), for which a value (102) for the number of lost grains (22) is determined.

23. The method for determining operating parameters of an agricultural harvesting header (4) as claimed in claim 18, further comprising:
utilizing the evaluation electronics (8) to calculate the values (102) determined with the image evaluation (10) for the number of lost grains (22) recognizable in the image data set (100) over a time interval (150) into a trend line (152);
registering any changes (154) made in the settings of one or more operating parameters of the harvesting header (4);
assigning the changes (154) temporarily to the trend line (152);
determining when there is a temporal coincidence between the beginning of a change (154) of the trend line (152) and the change (154) in the settings of one or more operating parameters;
assessing whether the trend line (152) increases or decreases since the change (154) in the settings of one or more operating parameters; and
utilizing the result of the assessment to generate a signal indicating whether the change (154) made in the settings of one or more operating parameters increases the determined grain losses, leaves them unchanged or decreases them.

24. The method for determining operating parameters of an agricultural harvesting header (4) as claimed in claim 18, comprising of determining that a value (102) determined by the image evaluation (10) for the number of lost grains (22) recognizable in the image data set (100) is used as the input to an automated software-controlled control loop, in which at least one first operating parameter of at least one adjustable first component of the harvesting header (4) is changed by control electronics in order to use the evaluation electronics (8) to assess, after the change (154) that has been made, by means of a new value (102), whether the loss level of the harvesting header (4) has been reduced by adjusting the first operating parameter and is assessed to be satisfactory;
continuing to change the first operating parameter of the first component until a loss level of the harvesting header (4), which is assessed to be satisfactory by the control electronics by means of a new value (102), is achieved;
changing at least one second operating parameter of the adjustable first component or of a second component of the harvesting header (4) by the control electronics in order to use the evaluation electronics (8) to assess, after the change (154) that has been made, by means of a new value (102) again, whether the loss level of the harvesting header (4) has been reduced by adjusting the second operating parameter and is assessed to be satisfactory;
changing the second operating parameter of the first or second component until a loss level of the harvesting header (4), which is assessed to be satisfactory by the control electronics by means of a new value (102) again, is achieved; and
adjusting one or more further operating parameters of the first, second, or other further component is continued by the evaluation electronics (8) until a setting of the operating parameters that are variably settable by the evaluation electronics (8), for which the harvesting header with the set operating parameters of the components has been set to the lowest possible loss level, has been achieved.

25. The method for determining operating parameters of an agricultural harvesting header (4) as claimed in claim 24, wherein the sequence of optimization of the individual operating parameters is variable depending on the respective field crop to be harvested, detected soil conditions, stored cereals that occur, yield map data from previous harvests, height of the harvested crop stock, degree of moisture and/or degree of maturity of the harvested crop.

26. The method for determining operating parameters of an agricultural harvesting header (4) as claimed in claim 18 wherein the value (102) determined by the image evaluation (10) for the number of lost grains (22) recognizable in the image data set (100), the trend line (152) and/or an indicator value derived therefrom are transmitted from the evaluation electronics (8) to a display unit (24) and displayed by the latter in a display (24a).

27. The method for determining operating parameters of an agricultural harvesting header (4) as claimed in claim 18, wherein the evaluation electronics (8) output an alarm signal when a preset or optionally settable threshold value for the value (102) determined by the image evaluation for the number of lost grains (22) recognizable in the image data set, the trend line (152) and/or an indicator value derived therefrom is exceeded.

28. The method for determining operating parameters of an agricultural harvesting header (4) as claimed in claim 18 wherein the evaluation electronics (8) store the determined values (102) for the number of lost grains (22) recognizable in the image data set, the trend line (152) and/or indicator values derived therefrom in a georeferenced manner in a loss map.

29. The method for determining operating parameters of an agricultural harvesting header (4) as claimed in claim 18 wherein the evaluation electronics (8) have interfaces (28) to external systems.

30. The method for determining operating parameters of an agricultural harvesting header (4) as claimed in claim 18 wherein the image data sets of lost grains (22), which are compared with the image data sets (100) transmitted by the optical sensor (6), are accessible in the image evaluation (10) of the evaluation electronics (8).

31. The method for determining operating parameters of an agricultural harvesting header (4) as claimed in claim 18 further comprising utilizing algorithms for self-learning systems that are integrated in the software of the evaluation electronics (8).

32. The method for determining operating parameters of an agricultural harvesting header (4) as claimed in claim 18 wherein the area (12), to which the optical sensor (6) is directed, is brightened during the creation of an image data set (100) by a light-emitting means (32) attached to the harvesting header (4).

33. A harvesting machine (2) comprising of a data processing device that includes software-supported image evaluation (10) of image data sets (100) of an optical sensor (6) in evaluation electronics (8), which optical sensor (6) is directed to an area (12) worked by the harvesting header (4), wherein the image evaluation (10) of the image data sets (100) generated by the optical sensor (6) is aimed at least approximately determining, as operating parameters, a value (102) for the number of lost grains (22) recognizable in the image data sets (100).

34. A computer program product comprising instructions comprising of image evaluation (10) of image data sets (100) of an optical sensor (6) in evaluation electronics (8), which optical sensor (6) is directed to an area (12) worked by the harvesting header (4), wherein the image evaluation (10) of the image data sets (100) generated by the optical sensor (6) is aimed at least approximately determining, as operating parameters, a value (102) for the number of lost grains (22) recognizable in the image data sets (100).
